(19) United States
(12) Patent Application Publication
(10) Pub. No.: US 2011/0163555 A1
(43) Pub. Date: Jul. 7, 2011

(54) Sliding Door and Window Locks

(75) Inventors: John Russell Watts, Albert Park Victoria (AU); Brendan George, Dingley Victoria (AU); David Greenbury, St. Kilda Victoria (AU)

(73) Assignee: AUSTRAL LOCK LTY LTD, Blackburn Victoria (AU)

(21) Appl. No.: 12/865,320

(22) PCT Filed: Sep. 29, 2009
(86) PCT No.: PCT/AU2009/001288

§ 371 Date: Jul. 29, 2010

(30) Foreign Application Priority Data
Sep. 29, 2008 (AU) 2008905067
Oct. 10, 2008 (AU) 2008905294
Oct. 17, 2008 (AU) 2008905414
May 4, 2009 (AU) 2009901937

(51) Int. Cl. E05B 65/08; E05B 9/00; E05B 3/00

(52) U.S. Cl. 292/336.3; 292/337

(57) ABSTRACT

A lock mountable relative to a moveable wing and including an engaging member supported relative to a casing and displaceable to an operative configuration to be cooperable in engagement to restrain the wing in a closed configuration and in which said cooperating configuration the lock presenting a visible interior portion that does not substantially interrupt the form of the wing.

### SUMMARY OF THE INVENTIONS AS CLAIMED

According to one aspect of the invention, there is a lock mountable relative to a moveable wing and including an engaging member supported relative to a casing and displaceable to an operative configuration to be cooperable in engagement to restrain the wing in a closed configuration and in which said cooperating configuration the lock presenting a visible interior portion that does not substantially interrupt the form of the wing

In a second aspect of the invention, the casing includes a front plate and the engaging member is displaceable in response to displacement of an unlatching member comprising a push plate that in the operative configuration occupies an opening in the front plate, said opening providing access to a handle operable portion of the lock.

In a third aspect of the lock, the push plate always remains substantially parallel to the front plate.

In a fourth aspect of the invention, the engaging member is connected to a support slide supported relative to the casing and biased towards an operative configuration, and wherein displacement of the push plate to the fully displaced position causes the support slide to become retained relative to the casing to restrain the engaging member in the inoperative configuration,

In a fifth aspect of the invention, there is a release plunger operable to free the support slide to allow it to be displaced to the operative configuration.

In a sixth aspect of the invention, there is an operating cylinder operable to displace the support slide from the inoperative configuration to allow it to be displaced to the operative configuration.

In a seventh aspect of the invention, there is a locking cylinder reconfigurable to restrain the support slide from being released from the inoperative.

In an eighth aspect of the invention, the interior side portion has substantially the same form as the adjacent side surface of the wing.

In a ninth aspect of the invention, the visible interior side portion includes an outer surface comprising the surfaces of the front plate and a push plate.

According to another aspect of the invention, there is a lock for a moveable wing substantially as described herein with reference to and as illustrated in the accompanying drawings.

The elements relating to the various aspects of the invention claimed within are identified within the specification as follows; where unless the context requires otherwise,

“Locks” or variations such as “lock” will be understood to include complete locks for wings and improvements in locks for wings that are transportable into other locks and locking devices without being limited to the complete locks described herein.

“Comprise” or variations such as “comprises” or “comprising” will be understood to imply the inclusion of a stated integer or group of integers but not the exclusion of any other integer or group of integers.

Positional prepositions such as “rear” and “forward” are used to assist in description of the preferred embodiments and with reference to the accompanying drawings and have in general, no absolute significance

“Overlap” and derivations such as “overlaps” implies at least in-part, occupying a same plane as.

“Meshes with” implies engaging with but without free movement in excess of working clearances—for example, meshing between an angularly displaceable shaft and a recess in an angularly displaceable pinion means that they both angularly displace together but the shaft may be able to displace longitudinally in relation to the pinion.

“Extent” will be understood to include area, form and shape.

Headings are included for convenience only and not to affect on interpretation.

“Preferably” or variations such as “prefer” does not imply that the form of an integer is restricted to that referred to as preferred, but implies adequate and if need be, able to adequately perform a function required by the invention.

“Alternative” or variations such as alternatively does not imply that the form of an integer is less or more preferred but simply implies adequate and if need be, able to adequately perform a function required by the invention.

“Improvements” does not imply that the form of an integer is restricted to that referred to as “improved”, but implies an alternative form of the integer/s “well suited” to particular applications and if need be, able to adequately perform a function required by the invention.

“Wing” or variations such as “wings” includes complete wings; improvements in wings and alternative forms of wing constructions transportable into other wings and other structures without being limited to the wings described herein, and more particularly, wings embraces wings configured as “doors”, “windows”, “shutters”, “screens” and gates,

“Structure” or variations such as “structures” implies a man-made fabrication consisting of one or more members and embraces complete structures; improvements in and alternative forms of constructions without being limited to the wings and described herein, structures more particularly embraces wings and more particularly wings configured as (or included in) doors, windows, window screens, gates and shutters,

“Member” is an identifiable entity having material form that may include one or more identifiable components.

“Material” includes elements, alloys, plastics and other substances.

“Aperture” and “recess” embrace a hole that extends from a surface while “aperture” in some contexts implies a hole that extends between surfaces.

“Handle” includes a knob and lever;

“Engaging Member” is a member displaceable into and out of engagement with an “Engageable Member”; when in engagement, the engaging member is in an operative configuration and when removed from the said engagement, the engaging member is in an inoperative position or configuration. In some locks, the operative position corresponds with an engaging member that is substantially fully displaced and the inoperative position corresponds with an engaging member that is substantially fully retracted. Within this specification, the terms “retracted” and “inoperative” will be used synonymously and “fully displaced” and “operative” will be used synonymously

“To engage” implies displacement of an “engaging member” into engagement with an “engageable member”.

“Disengage” means withdrawal of the engaging member from engagement.

“Latching” implies displacement of an “engaging member” into engagement with an “engageable member” under the action of biasing means.

Latching Member including a “Latch-Bolt” or “latch bolt” is a biased member capable of executing (or participating in) latching and includes bolts having a leading end that is chamfered or otherwise profiled on one or both sides.

“Auxiliary bolt” is a plunger that is operably associated with a latching

“Unlatching” means withdrawal from the operative configuration.

“Locking” means configuring the lock to restrain it from being disengaged and in some forms of locks employing deadlocking slides, it means restraining the deadlocking slide to restrain the bolt from being inwardly displaced in response to operation of the unlatching lever.

“Deadlocking” means to configure the lock to restrain the engaging member from being displaced from the operative configuration by external forces (in the case of a common lock for a hinged door, it includes restraining the bolt in a fully extended position). The deadlocking means is some forms includes a “deadlocking slide” that is displaceable to cooperate with the engaging member to restrain it against displacement and/or to restrain an unlatching lever from being operable to unlatch the bolt.

“French Door” means a door including a frame and a glass in-fill.

“Screen door” means a door including a hollow frame and an insect restraining in-fill such as fiberglass mesh, woven mesh or perforated metal mesh; a conventional security door is defined having a axial hollow having a Depth not exceeding 45 MM, a Width not exceeding 16 MM; an industry-standard door preparation has an elongated slotted aperture having a Width 14.5 to 16 MM and length substantially 147 MM.

“Lock Body” Includes an engaging member and a lock casing and an Australian conventional security door lock is able to fit within an industry-standard door preparation and has a lock casing not exceeding 45 MM in depth, a width not exceeding 16 MM and preferably a length substantially 147 MM.

“Mortise Lock” means a lock including a lock body, a strike plate, at least one handle assembly and a cylinder where the lock body is configured to be fitted within the frame of the wing.

“Cylinder” or “Single cylinder” means a substantially conventional lock cylinder comprising a separate sub-assembly that includes a key operable barrel within a cylinder housing and a “Free rotation-double-cylinder” is configured such that each barrel is connected with free movement to a cam that is free (between limits) to be angularly displaced while the barrels remain undisplaced

“Cross-Sectional View” in relation to figures should be interpreted as an orthogonal cross-sectional view defined by a plain orthogonal to the axis of the member in consideration.

Patent Specification shall be taken to include: a Body [comprising Title, Summary of the Invention, Description of the Preferred Embodiment and Figures] Claims and an Abstarct.

Unless the context requires otherwise, any prior publications and usage referred to herein, is not an assertion that any of this material forms part of the common general knowledge in the art in any other country at the priority date of any claim herein (or the priority date of any future claimed derived at least in part from this specification).

The inventions described within relate to the Sliding Door and Window Locks described in associated provisional patent applications filed 10 Oct. and 29 Sept. 2008 by the same Applicant and bearing the same Title, “Title Sliding Door and Window Locks” and they are hereby included by reference,

Where an integer is attributed with attributes different from those attributed in an earlier application on which this application relies for priority, the integer will be considered to be the same integer in a different form; where there is actual inconsistency, the latest description will prevail.

The integers described within relate to a) the various aspects of the invention as claimed within, and b) the various aspects of other inventions as will be claimed in divisional applications derived at least in part from this application.

### DESCRIPTION OF THE FIGURES

Notwithstanding any other forms that may fall within the scope of this patent specification, one preferred form of the invention will now be described by way of example only with reference to the accompanying drawings in which:

FIG. 1 is an (exterior) isometric view of a lock having an exterior operating cylinder,

FIG. 2 is an underside view of the interior lock portion in the latched configuration with the cylinder barrel in the undisplaced disposition,

FIG. 3 is a view of the lock of FIG. 2 adapted by rotation of the cylinder barrel in the direction shown to drive down the slide to the unlatched configuration,

FIG. 4 is a view of the lock of FIG. 3 adapted by further rotation of the cylinder barrel to return the cylinder barrel to the undisplaced disposition,

FIG. 5 is a view of the lock of FIG. 4 adapted by rotation of the cylinder barrel in the opposite direction to a position where further rotation will release the slide to allow it to be displaced upwardly to the latched configuration,

FIG. 6 is an exploded isometric view of the interior lock portion viewed from the interior,

FIG. 7 is an exploded isometric view of the interior lock portion viewed from the exterior,

FIG. 8 is a schematic side view of the interior lock portion in an unlatched configuration where the support slide is restrained against displacement,

FIG. 9 is the lock of FIG. 8 where the plunger has been depressed to release the slide,

FIG. 10 is the lock of FIG. 9 where the plunger is depressed and the support slide has displaced to the latching configuration,

FIG. 11 is an isometric schematic partly exploded view (from the interior) of the interior lock portion,

FIG. 12 an isometric schematic partly exploded view showing the lock of FIG. 11 viewed from the underside and the opposite side,

FIG. 13 is an isometric semi-exploded view of the interior lock portion mounted in the frame of a wing adjacent to a catch plate,

FIG. 14 is a schematic side cross-section of the lock of FIG. 13,

FIG. 15 is an isometric semi-exploded view of the engaging member and adjacent support slide,

FIG. 16 is a schematic side cross-sectional view of the lock of FIG. 15,

FIG. 17 is a schematic side cross-sectional view of the lock of FIG. 13 and isometric views of the casing ends,

FIG. 18 is an isometric view of the interior lock portion adapted to include a locking cylinder,

FIG. 19 is an isometric underside View of the interior lock portion of FIG. 18 in the unlocked configuration

FIG. 20 is an isometric underside, view of the interior lock portion of FIG. 18 in the locked configuration.

### DETAILED DESCRIPTION OF PREFERRED EMBODIMENTS CONSISTENT WITH CONCEPTS OF THE INVENTIONS

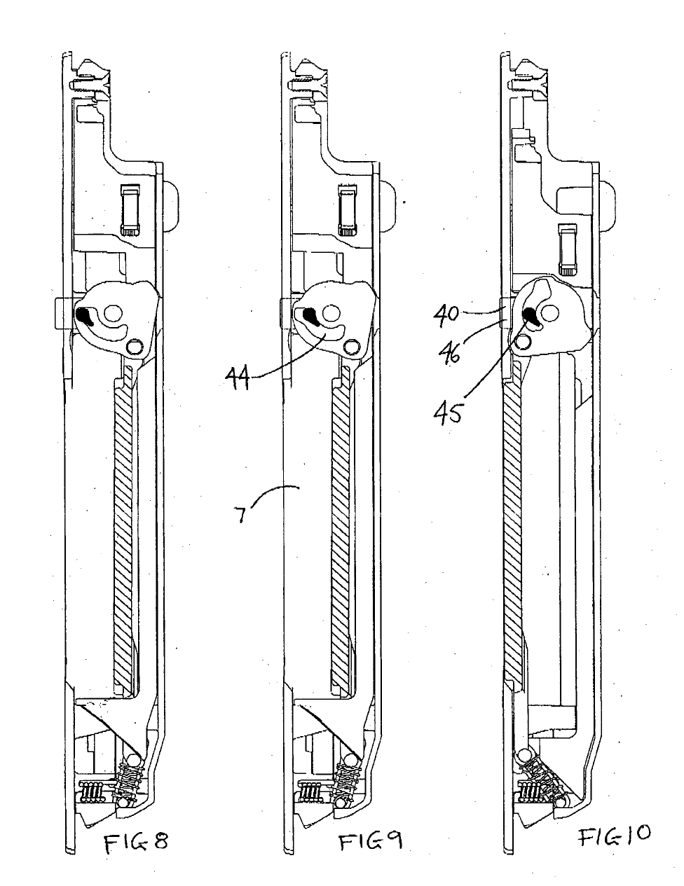

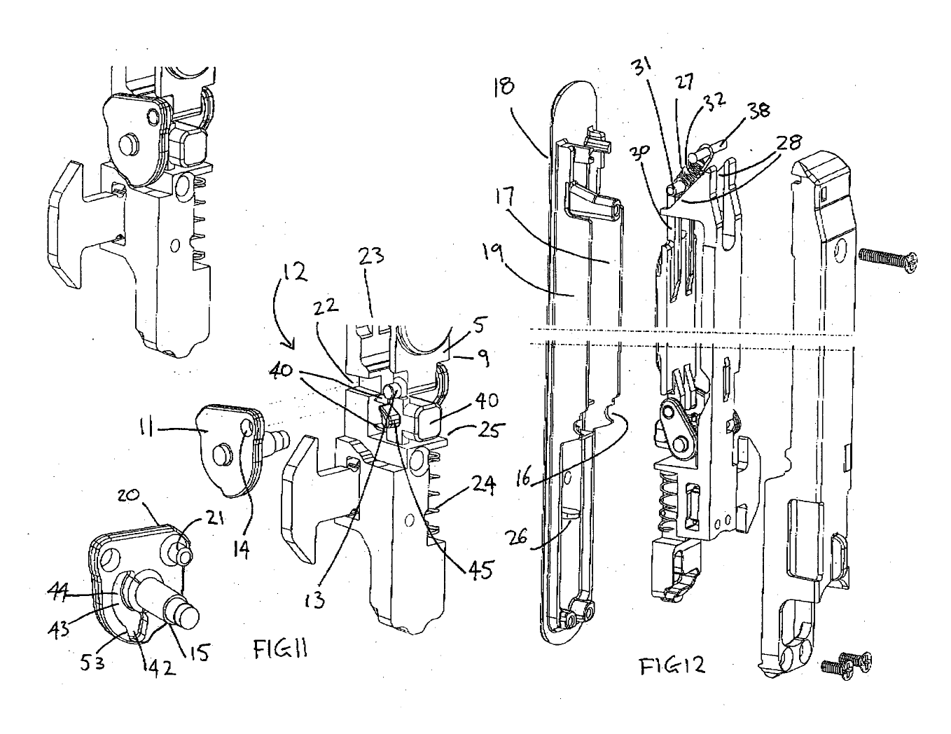

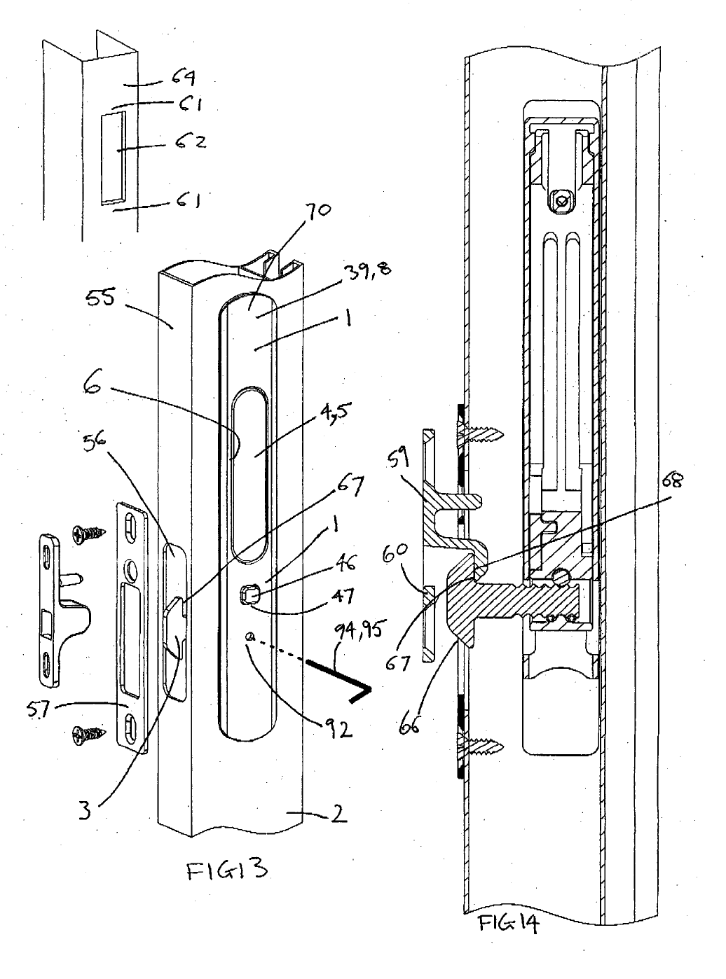

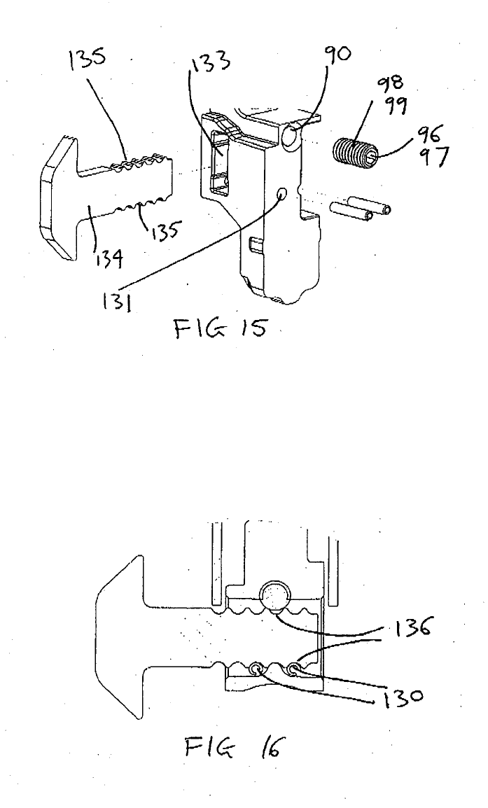

Some of the inventions described within this application include, referencing FIG. 1 and 13, a lock 1 for a moveable wing 2, the lock including a casing 70 comprising a substantially hollow box-like member that includes a front plate 8 having an opening 6 to a handle cavity 7 into which the hand is inserted to displace the wing. The lock 1 further including an engaging member 3 (supported by the casing 70 for substantially rectilinear displacement) that can be caused to displace from the operative configuration, referencing FIGS. 10 and 2, to the inoperative configuration referencing FIGS. 1, 8 and 3, by means that in some forms includes inward displacement of a disengaging member 4, that may take the form of a push plate 5 that in some forms, (in the configuration corresponding to the engaging member in the operative configuration) occupies the opening 6 to the handle cavity 7; the push plate 5 in some forms, remaining substantially parallel to the position it assumes when occupying the opening 6 when being displaced towards the fully displaced position; the push plate 5 in some forms having a raised portion that in its undisplaced configuration has an outer surface 39 that is substantially a continuation of the adjacent surface of the front plate 8. The above mentioned features help provide hand operation that is ergonomieally improved and for an appearance that does not significantly intrude into the general form of the wing and in some forms providing a lock of relatively inconspicuous appearance.

In some forms, referencing FIG. 11, the push plate 5 is connected at a first (lower) end 9 to the forward shoulder 10 of a rocker 11 by a first pin-joint 12 comprising a sideways protruding pin 13 of the push plate that extends to occupy an aperture 14 in the rocker 11; the rocker 11 supported about a shaft 15 supported relative to a side 17 of the casing by extending through an aperture 16 in that side; the shaft 15 extending in the opposite direction to similarly extend through an aperture in the opposed side 19.

The rocker 11 has a rear shoulder 20 supporting a sideways extending pin 21 that extends to occupy a slotted recess 22 in the side of a support slide 23 that is supported to displace rectilinearly. In some forms the immediately aforementioned pins and/or shafts are substantially cylindrical and have parallel axis disposed orthogonally to the direction of displacement of the push plate 5 and the support slide 23; each of the afore mentioned pins and/or shaft providing relative angular rotation.

The pins and/or shafts 15, 14, 21 and slotted aperture 22 are disposed such that a substantially horizontal force applied to the push plate 5 causes the pin 13 to exert a horizontal force on the walls of the aperture 14 and this force is characterized by having a direction that passes above the pivotal axis of the rocker 11 giving rise to a moment that causes the rocker 11 to rotate to draw the support slide 23 downwardly against a compressed compression spring 24 located between a bracket 25 protruding from the support slide 23 and a bracket 26 protruding from the underside of the front plate 8.

Some of the inventions described within are further configured such that the support slide 23 extends vertically to overlap the push plate 5 and the upper end 27 of the support slide 23 supports one and preferably a pair of ramped blades 28 that extend to the underside of the front plate 8 to keep upper end 27 adjacent to the internal face of the rear wall 29 of the front plate and a portion 30 of reduced width 9 (that may comprise a pair of spaced blades) of the push plate 5 extends between the ramped blades 28 and a bearing surfaces 31 of the push plate 5 (that may comprise a cylindrical bar) extends sideways to overlap (to interact with) the ramped blades 28 so that the support slide 23 can be displaced downwardly by inwards displacement of the adjacent end of the push plate 5; and in usage, inwards displacement of the push plate 5 (and in some forms, by a force applied substantially anywhere within Its length) causes the bar 31 to slide down the ramps 28 while the lower end 9 displaces inwardly under control of the rocker 11 to draw the support slide downwardly against the biasing force derived from the spring 24.

To help control the upper end 27 of the push plate 5, a compressed compression spring 32 is held between a sideways extending pin 33 and the bar 31; the pin 32 being characterized by being located between the horizontal position of the fully displaced push plate 5 and the undisplaced position of the push plate 5 so as to act as an over-centre device urging the upper end 27 towards these positions. In usage, inwards displacement of the push plate 5 causes the lower end 9 of the push plate to execute circular motion while the upper end executes follower motion defined by the bearing surfaces 31 sliding down the ramped blades 28 as they are displaced downwardly; the ramped blades 28 (and the arms of the rocker) being configured such that the push plate 5 (as it is displaced inwardly) always remains substantially parallel to the face 39 of the front plate.

In some forms, referencing 8, 9, 10, 11 a release plunger 40 has an upper and a lower spaced arm 41 that locate above and below the shaft 15 and a sideways protruding pin 45 extends into a profiled recess 44 in the underside of the rocker 11; the recess 45 consisting of a substantially circular portion 43 connected to an outwardly disposed portion 42. The release plunger also includes a handle operable pin 46 that extends forward to extend through an aperture 47 in the front plate 8 to protrude from the front plate. The elements are configured such that when the pin 46 is within the portion 43 the pin 46 is substantially withdrawn into the aperture 47 and when in portion 42, the pin 46 protrudes from the front plate 8 (from which position it can be displaced by hand to release the rocker 11 enabling it to be rotated under the action of spring 24. Release plunger includes an axial recess 49, referencing FIG. 7, housing a compressed compression spring 50 that is held between the shaft 15 and an end 51 of recess 49. In usage, displacement of the push plate 5 to the inoperative configuration (fully displaced) (to retract the engaging member) causes the rocker 11 to rotate to align the pin 45 with the portion 42 enabling the catch elide to be displaced outwardly under the action of spring 50 so the pin 46 protrudes from the front plate 8 and in this configuration, the rocker is restrained against displacement by the action of the pin 45 abutting an outwardly angled shoulder 53 of recess 44 that connects portions 43 and 42. When wing is closed, the pin 46 would be pushed inwardly to displace the pin 45 away from the angled shoulder 53 to release the rocker to enable the engaging member to be displaced to the operative configuration under the action of spring 24. In some cases, and in particular cases where the wing comprises a frame door or window, the lock would be mounted in a recess in a side of the closing edge of the wing and the engaging member 3 would extend through an aperture 56 in the closing edge 55 and in some cases through a front plate 57 mounted to the closing edge. An engageable member 59 would be mounted to an element 64 that defines in-part the opening adjacent to which wing is supported; the engageable member 59 and engaging member 3 relatively aligned to enable proper engagement, referencing FIG. 14. In some forms the engageable member 59 comprises a catch plate 60 and in other cases it comprises material 61 surrounding and defining a slotted aperture 62 in the element and in some cases, the engaging member 3 comprises a hooked member 66 having a vertically extending shoulder 67 (defining in part a hook) that is able to engage with by vertically overlapping a vertically extending shoulder 68 of the catch plate 60 (this engaged configuration corresponding to the operative configuration of the engaging member); and the engaging member 3 can be displaced from this to the configuration corresponding to the inoperative configuration, in which position the shoulders 68 and 67 do not vertically overlap and are free from engagement.

In some forms, the lock 1 would be mounted to the wing in a substantially conventional manner so that the box-like portion of the casing 70 occupied an aperture in the side of the wing having a similar shape and the flanges 73 of the casing overlap the periphery of the aperture. The lower end of the casing 70 has a recess 76 defined in part by a downwardly and inwardly projecting shoulder 75 and the upper end of the casing 70 (in the mounted state) has a recess 77 defined in part by an upwardly and inwardly projecting shoulder 78; shoulder 78 comprising part of an upwardly biased and downwardly displaceable slide 79; these features are configured such that during fitting, referencing FIG. 17, shoulder 75 is placed under the lower lip 80 of the aperture and the casing is pivoted towards the mounted configuration till a downwardly and inwardly angled shoulder 82 of the slide 70 (connected to shoulder 78) abuts an upper lip 81 of the aperture, whereupon the application of an inwardly directed force on the casing 7 causes the slide 70 to downwardly displace till the lip 81 leaves the shoulder 82 and enters recess 77; this being coincidental with the adjacent portion of the slide 79 abutting the surface of the side of the wing. In some forms, (and in particular in forms employing the pull-plate 100 described below and having an associated mounting aperture in the wing enabling through accessibility) a screw 85 intersects a vertically elongated aperture 86 of the slide 79 (the aperture providing unrestricted displacement of the slide so that it can displace during fitting) and this screw is tightened after fitting of the casing 70 to prevent subsequent displacement of the slide by an outwards force applied to the flange—this to more securely attach the casing 70 to the wing. The pull-plate 100 described below is similarly attached to the opposite side of the wing—referencing FIG. 17.

In some forms, referencing FIG. 1, the lock includes a pull-plate 100 comprising of a finger recess 101 and in some forms a key operable operating cylinder 102 mountable to the opposite side of the wing; the operating cylinder enabling the lock to be operated by means of a key from the opposite side of the wing (that normally would correspond with the exterior side).

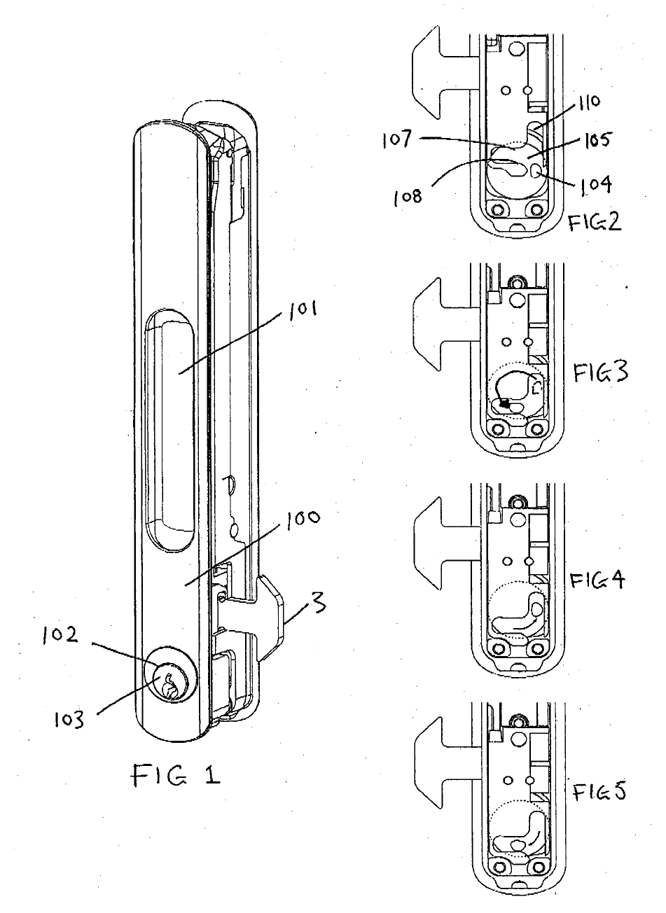

In some forms, the operating cylinder 102 comprises a plug 103 having a longitudinally elongated protruding tail 104 (radially displaced from the pivotal axis of the plug 103) that extends (through an aperture in the wing) into a profiled aperture 105 of the support slide 5; the aperture 105 defined in part by vertically spaced orthogonal walls 107 and 108 that overlaps the tail 104 and on which the tail acts to displace the support slide 5 such that when the operating cylinder plug 103 is rotated in a first direction, referencing FIG. 3, the tail 104 acts on the wall 108 to displace the support slide 5 in a downwards (disengaging) direction against the biasing of spring 24. The components are configured such that the engaging member 3 can be displaced from the operative configuration to the inoperative configuration by operation of the operating cylinder. During this movement, the protruding pin 45 of the catch slide 46 becomes aligned with and automatically occupies the recess portion 42 of the rocker 111 to cause the engaging member 3 to become restrained against displacement from the inoperative configuration. In usage, subsequent rotation of the operating cylinder in a latching direction, referencing FIG. 5, causes tail 104 to apply an upward force on the horizontal wall 107 of the support slide 5 to urge the support slide in an upward direction. This urges the rocker 11 to rotate which it turn urges the release plunger 46 to be inwardly displace. The lock is configured such that the operating cylinder is able to apply sufficient force cause the pin 45 (against outwards biasing) to slide along the (ramped or radiused) shoulder 53 (to displace inwardly). The shoulder as described before, connects recess 42 to the substantially circular portion of recess 43.

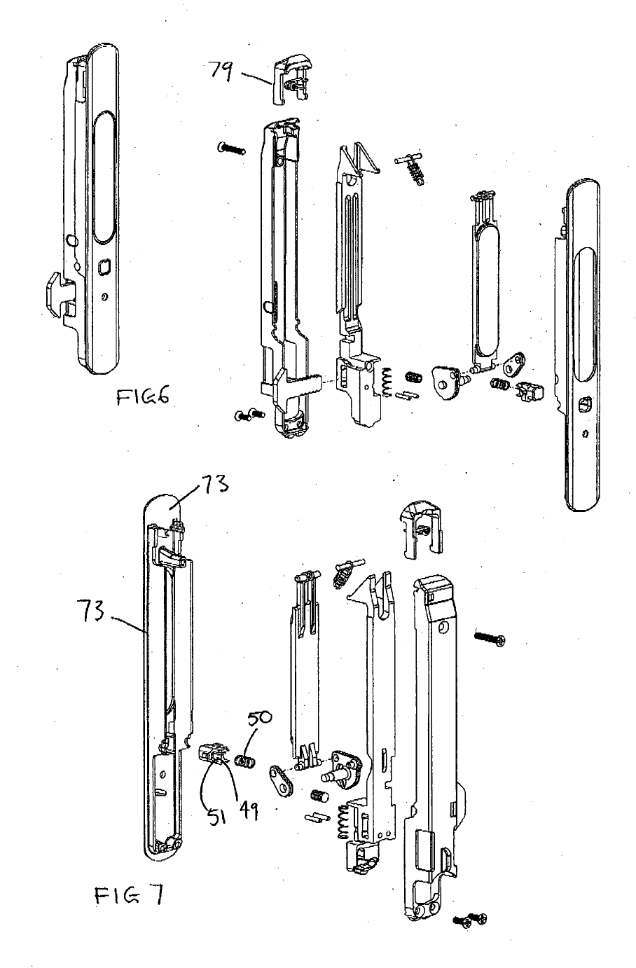

In some forms, referencing FIG. 2 and 4, the operating cylinder has one key removal configuration (corresponding to the undisplaced configuration of the barrel). In some forms, when in this undisplaced configuration, the lock is operable by the push plate 5 to displace to the inoperative configuration and in some forms, subsequently displaceable to the operative configuration upon inwards displacement of the catch slide 46. These requirements require the aperture 105 to include a vertically elongated portion 110 which can be occupied by the undisplaced pin 104 as the support slide (and hence aperture 105) are displaced in response to operation of the push plate 5. Further, the aperture 105 is further configured such that when the support slide is in an inoperative configuration, the pin 104 can be displaced from the undisplaced configuration to urge the support slide upwardly and when the support slide is in the operative configuration, the pin 104 can be displaced from the undisplaced configuration to urge the support slide downwardly.

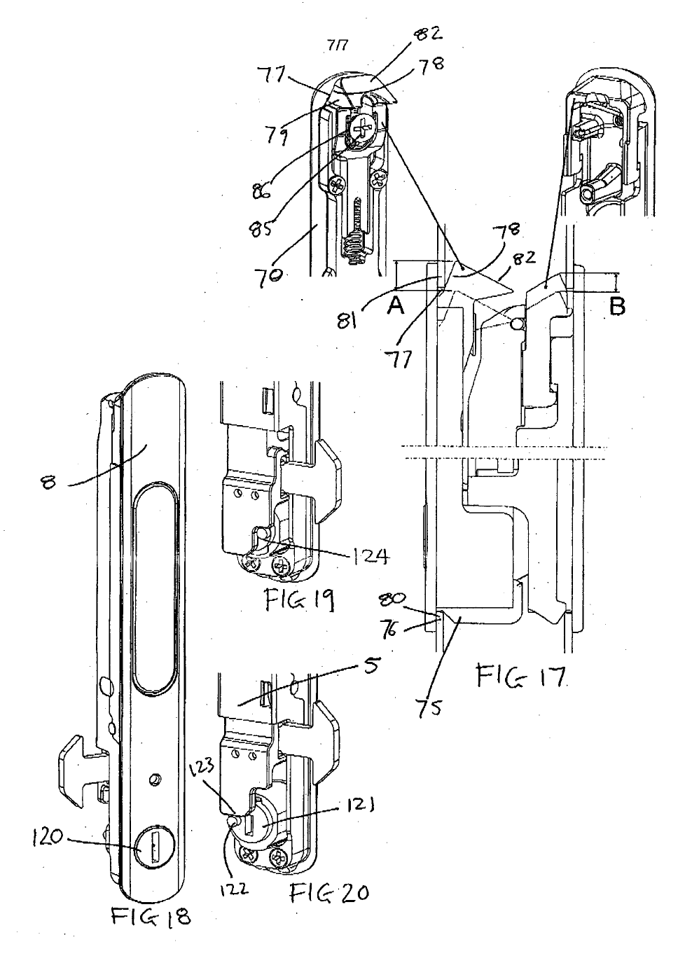

in some forms, referencing FIG. 18, (that in some forms does not include operating cylinder 102), a locking cylinder 120 is supported relative to the front plate 8. The locking cylinder comprises a plug 121 having a longitudinally elongated protruding tail 122 (radially displaced from the pivotal axis of the plug 121) that extends to (in the locking configuration corresponding to the operative configuration) horizontally overlaps a locking shoulder 123 of an adapted support slide 5 to prevent the support slide 5 from displacing from the upwardly disposed operative configuration. Adjacent to the locking shoulder 123, referencing FIG. 19 is a recess 124 of the adapted support slide 5 into which the tail 122 extends when the cylinder is not in the locking configuration, this corresponding to the inoperative configuration where the support slide is free to be displaced between the operative and inoperative configuration (by means not including the locking cylinder). it should be noted to locking cylinder has two key removal configurations, one corresponding to the locking configuration shown in FIG. 20 and one corresponding to the not jocking configuration shown in FIG. 19.

In some forms, the engaging member 3 is attached to the support slide 23 by an elongated support arm 134 of the engaging member 3 extending into a elongated recess 133 of the support slide defined in part by an axis parallel substantially with the direction of movement of the wing, this recess 133 being intersected by an internally threaded orthogonal recess 90 that in the inoperative configuration is coaxial with aperture 92, referencing FIG. 13, of the front plate 8 configured to provide free passage to a tool 94 (that may comprise an Alan key 95) that may be inserted into the drive recess 96 (that may comprise a hex recess 97) of an elongated fastener 96 (that may comprise a grub screw 99) supported in threaded engagement in recess 90. For better support, the support slide may further support spaced orthogonal pins 130 that extend into a elongated recesses 131 of the support slide so that the upper and lower profiled edges 135 of an elongated support arm 134 are held clamped between the fastener 98 on one edge and the pair of pins 130 on the other edge. In some forms, the profiled edges comprise spaced recesses 136 spaced so that both pins 130 and the fastener 98 can simultaneously occupy a separate recess 136. This arrangement enabling the fastener 98 to be removed from the recess 133 to enable the distance the support arm 134 extends from recess 133 to be adjusted, the fastener 98 to subsequently be tightened to secure the engaging member to the support slide.

Furthermore, the inventions within include a lock mountable to a wing and configurable to an operative configuration to cooperate in engagement to restrain the wing in a closed position; in some forms, the lock characterized by being substantially inconspicuous when cooperating in the aforementioned engagement. In some forms, the lock is further configured to present a surface visible from the interior side of the wing that has substantially the same form as the adjacent side surface of the wing. In some forms this surface comprises the surface of the front plate and the surface of the push plate. The aforementioned attribute enables doors and windows to include a lock but to do so without interrupting the appearance of the wing and/or without interrupting the view through the door or window. This attribute may be quite significant in same wing designs.

Within the scope of the inventions described above, is a simplified lock where the rocker is omitted and the push plate is supported relative to a hand recess within an adapted support slide that supports an engaging member as previously described; the push plate being outwardly biased. In operation the hand simply inwardly displaces the push plate to expose the hand recess and upward/downward force (applied by hand) on the walls of the hand recess causes the support side to displace upwardly/downwardly to be displaceable between operative and inoperative configurations respectively.

In some forms, the push plate is biased by compression springs located at the upper and lower ends of the push plate and between the push plate and support slide. In some forms, similarly as described above, the push plate (and casing) in its configuration corresponding to the operative configuration presents a surface visible from the interior side of the wing that has substantially the same form as the adjacent side surface of the wing as described in more detail above.

1. A lock mountable relative to a moveable wing and including an engaging member supported relative to a casing and displaceable to an operative configuration to be cooperable in engagement to restrain the wing in a closed configuration and in which said cooperating configuration the lock presents a visible interior portion that does not substantially interrupt the form of the wing,

2. A lock according to claim 1, wherein the casing includes a front plate and the engaging member is displaceable in response to displacement of an unlatching member comprising a push plate that in the operative configuration occupies an opening in the front plate, said opening providing access to a handle operable portion of the lock.

3. A lock according to claim 2, wherein the push plate always remains substantially parallel to the front plate.

4. A lock according to claim 2, wherein the engaging member is connected to a support slide supported relative to the casing and biased towards an operative configuration and wherein displacement of the push plate to the fully displaced position causes the support slide to become retained relative to the casing to restrain the engaging member in the inoperative configuration.

5. A lock according to claim 4, including a release plunger operable to free the support slide to allow it to be displaced to the operative configuration.

6. A lock according to claim 5, including an operating cylinder operable to displace the support slide from the inoperative configuration to allow it to be displaced to the operative configuration.

7. A lock according to claim 5, including a locking cylinder reconfigurable to restrain the support slide from being released from the inoperative configuration.

8. A lock according to claim 1, wherein the interior side portion has substantially the same form as the adjacent side surface of the wing.

9. A lock according claim 2, wherein the visible interior side portion includes an outer surface comprising the surfaces of the front plate and a push plate.

10. A lock for a moveable wing substantially as described herein with reference to and as illustrated in the accompanying drawings.
